(19) United States
(12) Patent Application Publication
(10) Pub. No.: US 2004/0170166 A1
(43) Pub. Date: Sep. 2, 2004

(54) Compression methods for packetized sonet/sdh payloads

(76) Inventor: Ron Cohen, Nes Ziona (IL)

Correspondence Address: Mark Friedman, Bill Polkinghorn, Discovery Dispatch, 9003 Florin Way, Upper Marlboro, MD, 20772, US

(21) Appl. No.: 10/477,891

(22) PCT Filed: May 23, 2002
(86) PCT No.: PCT/US02/16160

Related U.S. Application Data
(60) Provisional application No. 60/292,952, filed on May 24, 2001.

(51) Int. Cl. H04L 12/56

(52) U.S. Cl. 370/389

(57) ABSTRACT

A method for compressing a packetized SONET/SDH stream for transmission over a packet switched network, comprising identifying a C2 byte in the stream, and, based on the identification, applying a C2 byte-related compression algorithm to compress the stream. The C2 byte is either extracted by a packet processor from a packet payload or header, pre-configures within an ingress packetizer, or identified automatically from examining the SONET circuit sent from an egress packetizer back to an ingress packetizer. Various embodiments of the compression algorithms include algorithms based on identifications of unequipped C2=0x0, virtual tributaries C2=0x02, HDLC C2=0x16, PPP C2=0xCF, and asynchronous DS-3 C2=0X04.

### CROSS-REFERENCE TO RELATED APPLICATIONS

This application is entitled to the benefit of U.S. Provisional Application No. 60/292,952 filed 24 May 2001.

### FIELD AND BACKGROUND OF THE INVENTION

The present invention relates to methods of compressing packetized data streams, in particular SONET/SDH streams. SONET (Synchronous Optical Network) is a high-speed synchronous network specification developed by Bellcore and designed to run over optical fibers. SDH (Synchronous Digital Hierarchy) is the international version of the SONET standard. The differences between SONET and SDH specifications are minor, see for example American National Standards Institute, “Synchronous Optical Network (SONET)—Basic Description including Multiplex Structure, Rates and Formats,” ANSI T1.105-1995; ITU Recommendation G.707, “Network Node Interface For The Synchronous Digital Hierarchy”, 1996; and Telcordia Technologies, “Synchronous Optical Network (SONET) Transport Systems: Common Generic Criteria”, GR-253-CORE, Issue 3, November 2000. In the description hereinbelow, SONET terminology is used for both SONET and SDH, and SDH is mentioned explicitly only when the differences in specification are of importance.

The basic building block signal for SONET is the Synchronous Transport Signal level 1 (STS-1) operating at 51.84 Mbps. Higher speed SONET signals can be composed by Time Division Multiplexing (TDM) multiple STS-1 signals. For example, an STS-3 signal is composed of three STS-1 signals, where each byte in the stream alternates between the first, second and third STS-l components.

SONET frames are sent 8000 times a second. The SONET frame is composed of a transport overhead and a Synchronous Payload Envelope (SPE) that carries the data. The SPE carries overhead bytes and data payload. The 9 overhead bytes called Path Overhead (POH) include a byte that specifies the data signal type carried within the SONET payload, as well as other bytes used for various operation, alarms and maintenance tasks. The beginning of the SPE starts in an offset from the fixed frame transport header. A pointer within the transport overhead bytes (TOH) indicates the beginning of the SPE.

SONET higher rate signals can be concatenated to form a higher rate channel. The small ‘c’ in STS-3c indicates that the SPE is concatenated and includes only one POH and payload, instead of the time division multiplexing of three STS-1s.

STS can carry ATM cells, Packets, DS-3 and lower rate TDM circuits including T1 (1.544 Mbps) and E1 (2.048 Mpbs), called Virtual tributaries (VTs) in SONET terminology. The SONET transmission infrastructure carries multiplexed circuits of these various types.

The successful deployment of packet switched networks leads to a need to carry SONET circuits across a packet switched network. In other words, a SONET/SDH “stream” is carried as a “payload” over a packet switched network. In is the following description “stream” and “payload” are thus used interchangeably. A number of proposals have been made to address this need. A SONET packetizer apparatus receives SONET TDM signals, buffers the input byte stream, and pastes it as packet payload. The packet is sent over the packet transmission network until it reaches another SONET packetizer that extracts the payload from the packet and places it on the outgoing SONET signal. The packetizer may use a jitter buffer to compensate for the jitter of the packet transmission network. The packetizer is also responsible for various alarms, management tasks and fault condition handling. At present, there is no standard for carrying SONET circuits across packet switch networks, although some work is in progress, see for example The Internet Task-Force (IETF) at www.ietf.org, where work is being done within the PWE3 (pseudo wire edge to edge emulation) working group.

Packet switched networks statistically multiplex packet transmission. If the SONET over a packet payload can be compressed, less bandwidth is consumed, leaving room for other packet flows. Efficient compression of the SONET payload carried over the network is therefore desired. At present, the only proposed method for compressing SONET payload is for compression of unused (unequipped) STS-1 and STS-Nc containers.

There is thus a widely recognized need for, and it would be highly advantageous to have, a method for efficiently compressing packetized SONET/SDH payloads.

### SUMMARY OF THE INVENTION

The present invention is of a method for efficiently compressing packetized SONET/SDH payloads.

According to the present invention, there is provided a method for compressing a packetized SONET/SDH stream for transmission over a packet switched network, comprising identifying a C2 byte in the stream, and, based on the identification, applying a C2 byte-related compression algorithm to compress the stream.

According to a feature of the method of the present invention, the step of identifying includes extracting the C2 byte from the stream.

According to another feature of the method of the present invention, the step of identifying includes using pre-configured C2 information.

According to yet another feature of the method of the present invention, the step of identifying includes providing an ingress packetizer configured to apply the C2 compression, the compression resulting in a transmitted compressed stream, providing an egress packetizer configured to receive and decompress the transmitted compressed stream, and examining a SONET circuit sent back from the egress packetizer to the ingress packetizer.

According to a first embodiment of the method of the present invention, the step of applying a C2 byte-related compression algorithm includes applying an Unequipped C2=1x02 compression algorithm.

According to a second embodiment of the method of the present invention, the step of applying a C2 byte-related compression algorithm includes applying a Virtual Tributaries C2=0×02 compression algorithm.

According to a third embodiment of the method of the present invention, the step of applying a C2 byte-related compression algorithm includes-applying a HDLC C2=0x16 compression algorithm.

According to a fourth embodiment of the method of the present invention, the step of applying a C2 byte-related compression algorithm includes applying a PPP C2=0xCF compression algorithm.

According to a fifth embodiment of the method of the present invention, the step of applying a C2 byte-related compression algorithm includes applying an Asynchronous DS-3 C2=0x04 compression algorithm.

According to one feature in the second embodiment of the method of the present invention, the step of applying a Virtual Tributaries C2=0x02 compression algorithm further includes the substeps of removing fixed columns from a plurality of SPE columns and SPE rows included in the stream, reordering the SPE columns to obtain reordered columns, flipping between the reordered SPE columns and the SPE rows to provide a transformed stream, and compressing the transformed stream.

According to another feature in the second embodiment of the method of the present invention, the substep of removing fixed columns from the plurality of SPE columns includes removing columns 30 and 59 of the SPE columns.

According to yet another feature in the second embodiment of the method of the present invention, the step of reordering columns further includes the substeps of reordering a v-r content of the stream according to performing a VTG alignment of the SPE columns, and performing an interVTG alignment between the SPE columns.

According to yet another feature in the second embodiment of the method of the present invention, the substep of performing an interVTG alignment includes performing a column reordering process selected from the group consisting of a first process optimized for VT1.5s, a second process optimized for VT-2s, and a third process optimized for a combination of VT1.5s and VT2s.

According to one feature in the third embodiment of the method of the present invention, the step of applying a HDLC C2=0x16 compression algorithm further includes the substeps of removing fixed columns from a plurality of SPE columns and SPE rows included in the stream to obtain a transformed stream, and compressing the transformed stream.

According to another feature in the third embodiment of the method of the present invention, the substep of compressing the transformed stream includes a data compressing procedure selected from the group consisting of compressing the transformed stream using (1xFD, length) and compressing the transformed stream using (0xFD value, length).

According to one feature in the fourth embodiment of the method of the present invention, the step of applying a PPP C2=1xCF compression algorithm further includes the substeps of removing fixed columns from a plurality of SPE columns and SPE rows included in the stream to obtain a transformed stream, unscrambling the data stream, and compressing the transformed stream.

According to another feature in the fourth embodiment of the method of the present invention, substep of compressing the transformed stream includes a data compressing procedure selected from the group consisting of compressing the transformed stream using (1xFD, length) and compressing the transformed stream using (1xFD value, length).

According to a feature in the fifth embodiment of the method of the present invention, the step of applying an Asynchronous DS-3 C2=0x04 compression algorithm includes removing fixed and unused columns 2, 3, 30, 31, 59 and 60 from a plurality of SPE columns of the stream.

### BRIEF DESCRIPTION OF THE DRAWINGS

The invention is herein described, by way of example only, with reference to the accompanying drawings, wherein:

FIG. 1 shows a block diagram of a preferred embodiment of the system of the present invention;

FIG. 2 shows a block diagram of the various embodiments of the compression methods or algorithms the present invention, implemented based on the examination of the C2 byte;

### DESCRIPTION OF THE PREFERRED EMBODIMENTS

The present invention is of a method for efficiently compressing packetized SONET and/or SDH payloads for transmission over a packet switched network. The principles and operation of a method for efficiently compressing packetized SONET/SDH payloads for transmission over a packet switched network according to the present invention may be better understood with reference to the drawings and the accompanying description.

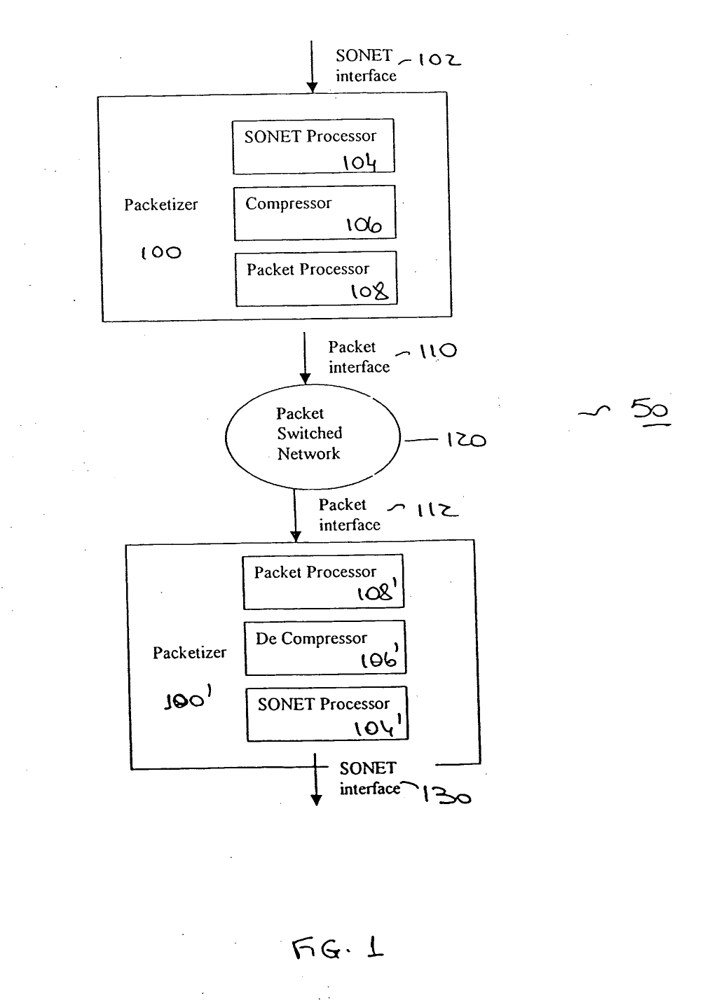

As shown in the block diagram of FIG. 1, in a preferred embodiment, the method of the present invention is implemented in a system 50 that includes an ingress packetizer 100 and an egress packetizer 100′, both packetizers capable of performing a number of operations or tasks. Each packetizer provides compression and/or decompression of a SONET payload based on the payload carried within the SONET STS-1 and STS-Nc signals, on top of the normal required tasks of a packetizer. In particular, each packetizer of the present invention provides different compression and/or decompression algorithms based on the SONET-POH C2 signal label byte.

The ingress and egress packetizers of the present invention are interchangeable in the sense that the SONET packet traffic is two-way trough the system. That is, packets can enter system 50 through packetizer 100 and exit through packetizer 100′ or vice versa. Hereafter, for convenience purposes, the discussion will center on data entering through (and being compressed in) packetizer 100 and exiting through (and being de-compressed in) packetizer 100′.

Packetizer 100 receives SONET data from a SONET interface 102 through a SONET Processor 104. SONET processor 104 extracts the SPE bytes that needs to be sent across a packet switched network 120 and identifies the SONET overhead bytes. For packetization of the SONET STS-1 circuit, the SPE extraction includes extracting the SPE content (783 bytes) starting from the first POH byte (the J1 byte). Then, SONET processor 104 examines and identifies the C2 byte within the SPE POH bytes. The SONET processor then forwards the SPE bytes to a Compressor 106, in which the payload is compressed using an algorithm suitable for the specific SONET STS-1 payload, and selected by the C2 byte. That is, in a key step of the present invention, the C2 byte serves as the identifier for the particular compression algorithm to be applied. The compression method of the present invention, in its various embodiments, is thus referred to as a “C2 byte-related compression algorithm” Next follows an encapsulation step done by a Packet Processor 108, in which the compressed payload is encapsulated in a packet. The SPE payload may be carried over a single packet, but may be transported on top of multiple packets when necessary. The packet is then sent via a first Packet Interface 110 to packet switched network 120. The packet travels across the packet switched network and through a second Packet Interface 112 to a second packetizer 100′, in which a reverse set of operations is performed by a packet processor 108′, a de-compressor 106′ and a second SONET processor 104′, the decompressed packet leaving system 50 through a second SONET interface 130.

Packetizer 100′ receives packets through a packet interface 112 and performs the operation in a reversed order. The C2 byte is either extracted by packet processor 108′ from the packet payload or header, pre-configured within packetizer 100, or identified automatically from examining the SONET circuit sent from packetizer 100′ back to packetizer 100. Thus, there are three main ways of “identifying” a C2 byte, such “identification” serving as a key step in each embodiment of the method of the present invention. The correct de-compression algorithm selected by the thus identified C2 byte is performed in de-compressor 106′, resulting in a decompressed payload. The decompressed payload is sent by SONET processor 104′ with the appropriate POH and payload bytes via SONET interface 120, possibly updating the necessary fields within the transport overhead bytes.

In addition to the tasks represented by steps 104, 106 and 108 (and the reverse tasks embodied by 108′, 106′ and 104′) above, a packetizer is responsible for performing other tasks, including handling errors and passing additional information within the packet, including other POH bytes.

When dealing with higher STS-N signals, such signals are first de-multiplexed to their STS-1 components and are sent separately on different packet flows. Higher concatenated signals are handled in the same steps. The only difference is that the SPE payload is larger and therefore there is higher chance that the payload will be sent over multiple packets.

Some of the compression algorithms of the present invention, as detailed below, can be used even if other encapsulation techniques are used. An example of an encapsulation technique under development in the art (that can be used with the compression algorithms of the present invention) involves encapsulating the SONET SPE including the POH bytes without aligning the payload to start following the J1 POH byte. In this method the TOH pointer are carried within the payload header.

SONET provides a number of error monitoring bytes. The B1 and B2 bytes are used for error monitoring of the STS-1 frames. The B1 and B2 bytes are part of TOH and are therefore checked and recalculated on each SONET link. The B3 byte is part of the POH and is used for error monitoring of the SPE. The B3 byte is checked and recalculated at SONET path termination nodes. The B3 byte is calculated as the bit-interleave parity of the previous SPE. Packet networks have other methods for error monitoring. For example when a SONET payload is encapsulated over RTP/UDP/IP protocols, UDP's 16-bit checksum field provides payload error monitoring. The packet network error monitoring mechanisms replace the B1 and B2 SONET error mechanism, and may replace the SONET B3 mechanism as well. Each packetizer inserting the SONET payload back into the TDM channels may recalculate the B3 byte. If it is required to maintain the B3 error mechanism across the packet network, some care should be taken when compressing SONET payload. The specifics within each compression mechanism are detailed within each section describing the algorithms.

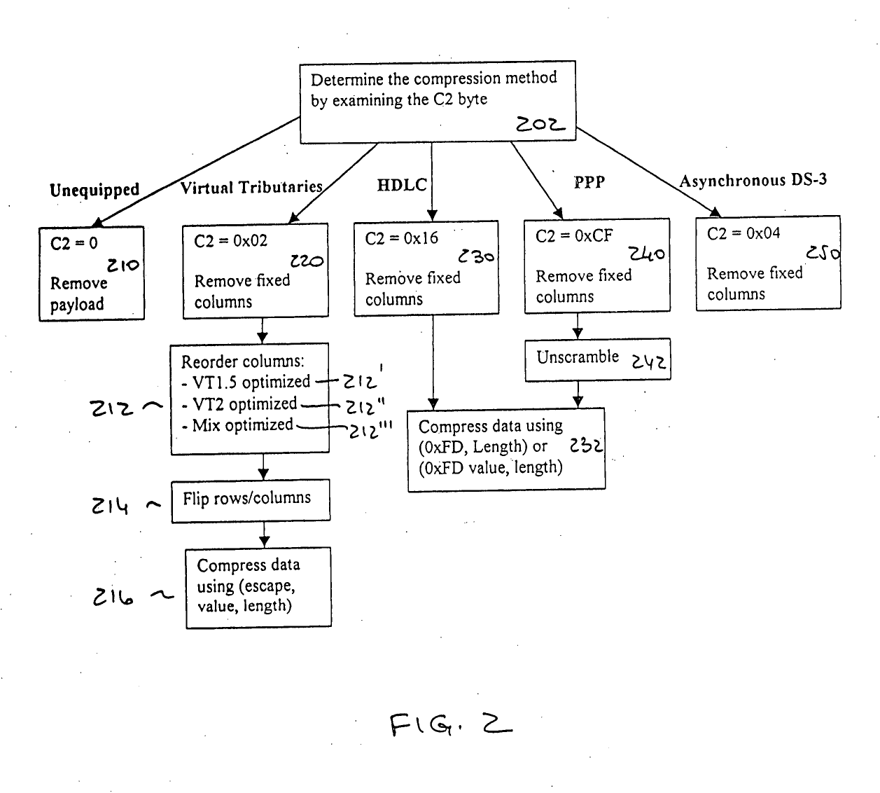

FIG. 2 shows a block diagram of the various embodiments of the compression methods or algorithms the present invention, implemented based on the examination of the C2 byte. As mentioned above, during compression, the identification of the C2 byte is done in SONET processor 104 (FIG. 1), while the compression is done in compressor 106. In FIG. 2, a choice of the compression method step 202 leads to one of five method embodiments:

| | |
|---|---|
| 1. Unequipped C2 = 0x0 | (block 210) |
| 2. Virtual Tributaries C2 = 0x02 | (block 220) |
| 3. HDLC C2 = 0x16 | (block 230) |
| 4. PPP C2 = 0xCF | (block 240) |
| 5. Asynchronous DS-3 C2 = 0x04 | (block 250) |

Unequipped C2=0x0 block 210. In this case, existing in the art, unequipped signals carry no meaningful payload, and the ingress packetizer discards the complete SPE payload and sends the packet indicating the unequipped signal within the payload header.

Virtual Tributaries C2=0×02 block 220. In this case, a STS-1 carries VTs in 7 Virtual Tributary Groups (VTGs). A VTG can either carry 4 VT1.5s holding a T1 each, 3 VT2s carrying an E1 each, 2 VT3s carrying a DS1-C signal each or a VT6 carrying a single DS-2; The VTGs are multiplexed byte wise. The SPE payload is usually described in terms of matrix of 86 columns by 9 rows. Bytes within the matrix are sent one row after the other. The matrix representation is useful because the byte multiplexing of VTG and VT within the SPE payload turns out to also be column wise multiplexing. That is, the bytes of VTG1 occupy the 12 columns: 2, 9, 16, 23, 31, 38, 45, 52, 60, 67, 74 and 81 of the SPE where column 1 is the POH (we use the standard column count). The first VT1.5 of the first VTG occupy the 2, 31, 60 SPE columns. Similarly, every VT within a VTG occupies a fixed set of columns within the SPE. Since there are 7 VTGs, each occupying 12 columns, 2 columns are left unused. Columns 30 and 59 of the SPE are not used and usually have bytes with constant values.

VT bytes hold both VT overhead bytes (VTOH) as well as data. VTs can either carry data or not be used as all (unequipped). In many cases the information bytes in unequipped VTs are constant (either 0x0 or 0xFF). Other VTs may be carrying constant bytes. For example, a VT1.5 may be carrying an unchanneled T1 circuit used for carrying packets. During non-working hours the line may be idle therefore carrying only an HDLC idle flag with a constant 0x7E value. The compression algorithm uses the fact that regardless of the VTG content, each column belongs to one VT. Therefore, if this VT is unequipped, most bytes of the column will be of fixed value and therefore easily compressible.

In the second (Virtual Tributaries) method embodiment based on C2=0x02, the compression is done in three stages, after removal of fixed columns: in this removal, the unused columns 30 and 59 are removed from the payload. Removal of these columns does not affect the POH B3 calculation because these columns carry fixed value bytes and therefore each column cancels the other's contribution to the parity calculation. The three compression stages are: 1) reorder the SPE payload columns 212, 2) flip between rows and columns of the SPE payload 214, and 3) compress 216.

Reorder SPE payload columns 212: the reordering of the SPE payload columns is preferably done in two sub-stages: a) VTG alignment and b): Inter VTG alignment

a. VTG alignment: the SPE payload columns are reordered such that the first 12 columns contain VTG-1, the second 12 columns contain VTG-2, followed by all other VTGs up to VTG-7. Within each VTG, the column order is kept. For example, the first VTG would occupy columns 2 until 13, while the original columns 2, 9, 16, 23, and so on would occupy columns 2, 3, 4, 5, respectively.

b. Inter VTG alignment: columns within each of the VTGs are reordered to maximize the possibility of compressing unequipped or idle circuits. The column alignment is done for each VTG in the SPE payload. A simple exemplary algorithm is defined below.

Lets look at a single VTG, and number its columns from 1 to 12. Table 1 (“background”) below numbers the columns that belong to each circuit according to the VT type carried within the VTG:

TABLE 1
Columns occupied by VTs within a VTG

| VT#1 Co | | |
|---|---|---|
| 1, | 2, | 3, |
| 1, 3, 5, | 2, 4, 6, 8 | |
| 1, 2, 3, 4, 5, 6, 7, 8, 9, 10 | | |

In InterVTG alignment, when the VTG carries VT1.5 circuits, and, VT#1 is unequipped, columns 1, 5 and 9 would carry fixed byte values. Reordering of these three columns sequentially would increase the length of continuous fixed bytes when reading the SPE payload column-wise. But if the VTG carries VT2 circuits, columns 1, 5 and 9 each belong to a different VT, and therefore if one of the VT2s were unequipped, say VT#1, only one sequential column would carry fixed bytes.

Several approaches can be taken here. Either the algorithm examines the data dynamically and adapts the column order on the fly, adding the information on the selected column order needed for decompressing to the payload header, or some fixed optimization agreed by the compressor and de-compressor is done in selection of the column order.

SONET is mainly used in North America and Japan, and mostly carry VT1.5 in VT mode. SDH is used in all other parts of the world and mainly carry VT2-equivalent called TU-12 in VT mode. Several optimizations of fixed column reorder in the interVTG alignment substep are therefore in order, and are shown inside box 212. A first process 212′ optimized for VT1.5s, a second process 212″ optimized for VT-2s, and a third process 212′″ optimized for a combination of VT1.5s and VT2s. The optimizations can either be selected according to whether SDH or SONET is used, or can be chosen by configuration.

The first optimization process, i.e. optimized VT1.5 column selection 212′, orders the columns inside a VTG such that three columns of each VT1.5 are always sequential. VT1.5#1 and VT1.5#3 are put in sequential order to optimize the compression of unequipped VT3s. The columns of each VT1.5 are ordered such that the last column of each VT1.5 and the first column of the next VT1.5 belong to the same VT2. The columns are preferably? ordered such that each VT2 has two sequential columns. The first VT column remains the first as it always carries an overhead byte as its first byte. A preferred VT1.5 optimized column order is therefore:

(1, 5, 9), (3, 7, 11), (2, 6, 10), (4, 8, 12)

The second optimization process, i.e. optimized VT2 column selection 212″ orders the columns inside a VTG using the same algorithm as above, such that VT2 columns are always ordered sequentially. To optimize towards VT3 (although an SDH equivalent is not defined), the even columns and odd columns are put in sequential order. Last, the columns of the VT2s are ordered such that the last column of one VT2 and the first column of the next VT2 belong to the same VT1.5. A possible VT2 optimized column order is therefore:

(1, 7, 4, 10), (2, 8, 11, 5), (9, 3, 6, 12)

In the third, “mixed” optimization process 212′″ in which the optimized column order is a compromise between VT2 and VT1.5 optimization, the optimizing is done for at least two sequential columns for each of the possible VT2 or VT1.5. A possible VT2VT1.5 optimized column order is therefore:

(1, 7), (3, 9), (5, 11), (2, 8), (4, 10), (6, 12)

After the columns are reordered, the compressor flips columns and rows in substage 214 resulting in a “transformed payload” or transformed stream”. Compressor 106 (FIG. 1) now compresses the transformed payload in substage 216, FIG. 2. Several compression algorithms can now be employed:

The simplest compression algorithm (referred to hereafter as “the normal length compression using the (escape, length, value) byte”) suitable for compressing unequipped and idle circuits, replaces contiguous bytes carrying the same value with an indication of value and length of the stream. The compression is done using a special escape byte that indicates that a counter byte and optionally a value byte follow. The escape byte used is 0xFF. The length byte is limited to values below 0xFF, and indicates the number of additional consecutive value bytes. A length of 2 therefore means that 3 consecutive value bytes appear in the original payload. If 0xFF appears in the payload, an escape byte followed by a length 0 byte is inserted to the output. If two consecutive 0xFF bytes appear in the payload, an escape byte followed by a length 1 byte is inserted to the output. Else, the normal compression using the (escape, length, value) byte is used. Therefore, the compressed output size increases only when a single 0xFF escape characters appears in the original payload. If the total length of the output is larger than the original payload, the payload may be sent uncompressed.

HDLC C2=0x16, Block 220 and PPP C2=0xCF, Block 230

The HDLC and PPP method embodiments are similar in all but one aspect. The PPP has an “unscramble” substep 242 (FIG. 2) while the HDLC does not. Below, HDLC is described in detail, with PPP described separately only in the context of differences vs. HDLC.

The IETF standard RFC-2615 available from www.ietf.org specifies how to run the Point-to-Point Protocol (PPP) over SONET/SDH. IP packets are encapsulated in a PPP header, and a Frame Check Sequence (FCS) trailer is added. Then, HDLC byte stuffing is performed. A synchronous scrambler is then optionally used. The Path Signal Label (C2) is set to 0x16 to indicate PPP with X\mathring{}43+1 scrambling. If the scrambling has been configured to be off, then the value 0xCF is used for the Path Signal Label to indicate PPP without scrambling.

The HDLC byte stuffing uses the control escape byte 0x7d to make sure that the flag byte 0x7E and the control escape byte do not appear within the packet payload. In some cases, other bytes are escaped as well. The IETF RFC-1662 standard includes a full explanation on the byte stuffing procedure.

Fixed Columns Removal in HDLC 230: The RFC-1662 standard specifies that within some SONET and SDH containers, HDLC would not occupy the whole SPE payload. In STS-1, columns 30 and 59 are left constant. Regardless of the standards, some implementations do integrate these columns as part of the payload used by HDLC frames. In SDH Vc-4-Nc where N=4, 16, 64 (equivalent to STS-12c-SPE, STS-48c-SPE and STS-16c-SPE, the first N−1 columns are not used for data as well, but are not used and populated with constant value bytes. Once more, some users in present practice do use these columns to transfer data.

The compression algorithm needs to know whether these columns carry data or not. If the columns do not carry data, they are preferably removed prior to unscrambling the payload (for the PIP method embodiment discussed below). Even if no scrambling is done, the unused columns arc preferably removed to improve compression.

Since the number of fixed columns within the SDH Vc-4-Nc containers is odd, there is a chance that removal of these columns would change the parity calculation of the B3 byte. If the B3 byte is carried over the packet network then the ingress packetizer recalculates the B3 byte to include only parity of the remaining SPE payload. As the fixed stuff bytes carry constant bytes, their bit-parity is constant as well. The new B3 byte is calculated to be equal to the bit-wise parity of the incoming B3, with a single byte taken from the fixed column. As the calculation does not include re-calculation of the parity of the SPE payload, the B3 role detecting errors end to end prevails. Note that the SONET/SDH standards specify other situations where the B3 byte is recalculated in an intermediate node for other purposes (tandem connections) in a similar way. The egress packetizer can either fill the stuff columns with zero bytes, or it can recalculate the B3 value in the same fashion otherwise.

HDLC compression, block 232: In order to compress the HDLC SONET payload, the normal (escape value length) compression method described previously can be used. The only difference is that instead of using the 0xFF as the compression escape byte, the HDLC flag byte 0x7E is used. This limits the compression length to be maximally 0x7D=125 bytes. Using the HDLC flag byte 0x7E as the compression escape byte minimize the chance that compression output size would increase.

Another, alternative, simple predictive compression algorithm compresses only HDLC flag bytes, by appending length after the HDLC flag. In this embodiment, the HDLC flag byte sequence is replaced by a single HDLC flag byte followed by the length of the sequence. This saves a byte whenever a sequence of more than two HDLC flags appears (inter-frame-gap of more than 2 bytes). This compression method is safe as it limits the possible expansion of the compressed output. The compression ratio is predictive per usage of the PPP circuit. A PPP circuit that uses half of its available bandwidth would consume approximately half of the bandwidth when carried over the packet infrastructure. Implementation may therefore be able to reserve only the resources required from the packet transmission network if the rate of the PPP circuit is controlled.

PPP Unscrambling, block 242: When the information is scrambled, straightforward compression does not lead to the desired results. Therefore, unscrambling of the data is required. A schematic scrambler is shown below (taken from RFC-2615):

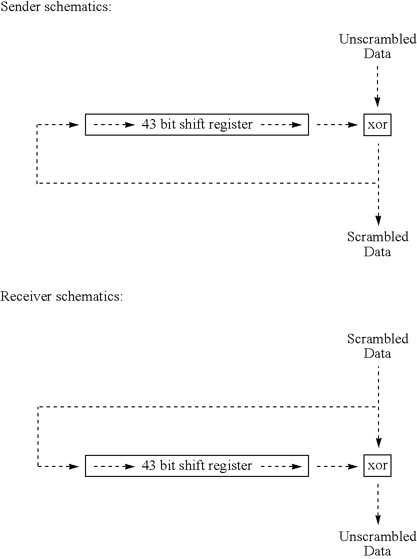

The ingress packetizer runs a receiver scrambler prior to compression of the payload. The egress packetizer runs the sender scrambler after de-compressing the packet payload and before insertion of the byte stream into the SONET interface.

RFC-2615 specifies that the initial 43-bit scrambler seed (i.e. the initial content of the shift register) be randomly chosen by transmitter to improve operational security. Consequently, the first 43 transmitted bits following startup or reframe operation will not be de-scrambled correctly. The additional unscrambling and re-scrambling done at the ingress and egress points of the packet network does not modify the packet content as long as the two scramblers are synchronized. The initial seed used by the ingress and egress scrambler should be the same. Otherwise, the first 43 bits will not be scrambled back to their original values, and the B3 parity would fail.

When a packet is lost, the synchronization fails. The ingress packetizer is not aware of the lost frame and continues to unscramble the data, but the egress cannot guess the last 43 bits in order to re-synchronize. For example, suppose that each packet carries a single SPE payload. Suppose that the nth packet does not reach the egress packetizer. When the egress packetizer receives the n+1 packet it knows that the nth packet is lost. The egress packetizer needs to handle this error condition. It also needs to minimize the effect of the error condition to this single lost packet. When the n+1 packet arrives, the egress scrambler knows that it has lost synchronization with both the ingress unscrambler and the unscrambler at the end of the SONET Path on the TDM circuit. Loss of synchronization is natural when a frame is lost or an SPE is corrupted. But there is a need to minimize the effect of the packet loss such that no more than the necessary damage would be done. When B3 parity byte is carried over the packet network, the B3 byte carried by the n+2 packet holds the bit parity of the n+1 SPE. Since the synchronization with the ingress unscrambler is lost, the scrambler cannot reconstruct the original content of the packet and therefore the parity would be broken.

There are two solutions to this problem. The most obvious one would be to recalculate the B3 parity byte of the n+2 packet. The drawback is that end-to-end parity check is lost for this SPE. The alternative is to always make sure that the ingress unscrambler and the egress scrambler are synchronized. This can be done by adding to each packet the last 43 bits (48 bits to keep byte alignment) of the previous SPE. Once the egress packetizer finds out that a packet is lost, is uses these 43 bits to re-synchronize the egress scrambler. The egress scrambler just scrambles these 43 (or 48) bits prior to starting to scramble the SPE payload.

Asynchronous DS-3 C2=0x04, Block 250

When C2=0x4, the SONET STS-1 carries an asynchronous DS-3 44.736 Mbit/s channel. Asynchronous DS-3 mapping into the SPE of STS-1 is structured such that:

1. Columns 30 and 59 are not used at all and carry fixed bytes.

2. Columns 2, 3, 31 and 60 carry fixed bytes

3. Other bytes carry information payload bits.

In this embodiment, the compression method separates between the information payload bytes that are not compressed, and the unused and fixed bytes that are. In particular, the method performs the following:

Remove fixed and unused columns 2, 3, 30, 31, 59 and 60 from the payload.

All publications, patents and patent applications mentioned in this specification are herein incorporated in their entirety by reference into the specification, to the same extent as if each individual publication, patent or patent application was specifically and individually indicated to be incorporated herein by reference. In addition, citation or identification of any reference in this application shall not be construed as an admission that such reference is available as prior art to the present invention.

While the invention has been described with respect to a limited number of embodiments, it will be appreciated that many variations, modifications and other applications of the invention may be made.

What is claimed is:

1. A method for compressing a packetized SONET/SDH stream for transmission over a packet switched network, comprising:
i. identifying a C2 byte in the stream, and
ii. based on said identification, applying a C2 byte-related compression algorithm to compress the stream.

2. The method of claim 1, wherein said step of identifying includes extracting said C2 byte from the stream.

3. The method of claim 1, wherein said step of identifying includes using pre-configured C2 information.

4. The method of claim 1, wherein said step of identifying includes:
i. providing an ingress packetizer configured to apply said C2 compression, said compression resulting in a transmitted compressed stream,
ii. providing an egress packetizer configured to receive and decompress said transmitted compressed stream, and
iii. examining a SONET circuit sent back from said egress packetizer to said ingress packetizer.

5. The method of claim 1, wherein said step of applying a C2 byte-related corr

6. The method of claim 1, wherein said step of applying a C2 byte-related compression algorithm includes applying a Virtual Tributaries C2=1x02 compression algorithm.

7. The method of claim 1, wherein said step of applying a C2 byte-related compression algorithm includes applying a HDLC C2=0x16 compression algorithm.

8. The method of claim 1, wherein said step of applying a C2 byte-related compression algorithm includes applying a PPP C2=1xCF compression algorithm.

9. The method of claim 1, wherein said step of applying a C2 byte-related compression algorithm includes applying an Asynchronous DS-3 C2=0x04 compression algorithm.

10. The method of claim 6, wherein said step of applying a Virtual Tributaries C2=0x02 compression algorithm further includes the substeps of:
i. removing fixed columns from a plurality of SPE columns and SPE rows included in the stream,
ii. reordering said SPE columns to obtain reordered columns,
λ. flipping between said reordered SPE columns and said SPE rows to provide a transformed stream, and [symbol]
. compressing said transformed stream.

11. The method of claim 10, wherein said substep of removing fixed columns from said plurality of SPE columns includes removing columns 30 and 59 of said SPE columns.

12. The method of claim 10, wherein said step of reordering columns further includes the substeps of reordering a VT content of the stream according to:
χ. performing a VTG alignment of said SPE columns, and [symbol]
. performing an interVTG alignment between said SPE columns.

13. The method of claim 12, wherein said substep of performing an interVTG alignment includes performing a column reordering process selected from the group consisting of a first process optimized for VT1.5s, a second process optimized for VT-2s, and a third process optimized for a combination of VT 1.5s and VT2s.

14. The method of claim 7, wherein said step of applying a HDLC C2=0x16 compression algorithm further includes the substeps of:
i. removing fixed columns from a plurality of SPE columns and SPE rows included in the stream to obtain a transformed stream, and
ii. compressing said transformed stream.

15. The method of claim 14, wherein said substep of compressing said transformed stream includes a data compressing procedure selected from the group consisting of compressing the transformed stream using (0xFD, length) and compressing the transformed stream using (0xFD value, length).

16. The method of claim 8, wherein said step of applying a PPP C2=1xCF compression algorithm further includes the substeps of:
i. removing fixed columns from a plurality of SPE columns and SPE rows included in the stream to obtain a transformed stream,
ii. unscrambling the data stream, and
iii. compressing said transformed stream.

17. The method of claim 16, wherein said substep of compressing said transformed stream includes a data compressing procedure selected from the group consisting of compressing the transformed stream using (1×FD, length) and compressing the transformed stream using (1×FD value, length).

18. The method of claim 9, wherein said step of applying an Asynchronous DS-3 C2=0x04 compression algorithm includes removing fixed and unused columns 2, 3, 30, 31, 59 and 60 from said SPE columns.
